(19) United States
(12) Patent Application Publication
(10) Pub. No.: US 2011/0041239 A1
(43) Pub. Date: Feb. 24, 2011

(54) TATTOOED NYLONS AND RELATED METHODS

(76) Inventor: Randy Altig, Kirldand, WA (US)

Correspondence Address: PERKINS COIE LLP;PATENT-SEA, P.O. BOX 1247, SEATTLE, WA, 98111-1247, US

(21) Appl. No.: 12/828,062

(22) Filed: Jun. 30, 2010

Related U.S. Application Data
(60) Provisional application No. 61/271,489, filed on Jul. 22, 2009.

(51) Int. Cl. A41B 11/04; B41J 2/01

(52) U.S. Cl. 2/409; 347/104

(57) ABSTRACT

Processes for printing designs onto sheer fabric using a heat press are disclosed herein. The processes print realistic tattoo designs that create the illusion that a wearer has a permanent tattoo on his or her skin. The processes may include printing a design on sublimation paper using dye sublimation ink, positioning the sublimation paper on a sheer fabric, and applying a high temperature, high pressure heat press to create a permanently dyed garment. The process may also include other inks such as, but not limited to, optic color ink and ultra-violet florescent ink. Additional embodiments include processes for printing images other than tattoos onto sheer fabrics, e.g., muscle definition, body paint, and branding. The products disclosed herein include hosiery and lingerie having realistic tattoo designs printed thereon.

### CROSS-REFERENCE TO RELATED APPLICATIONS

This application is a non-provisional patent application that claims the benefit of and priority to U.S. Provisional application No. 61/271,489, titled COMMANDHOSE, filed Jul. 18, 2009, which is incorporated herein by reference in its entirety.

### TECHNICAL FIELD

The present invention relates to tattooed sheer fabric and a process for applying ink onto sheer material, and more specifically to applying a design resembling a tattoo onto sheer garments.

### BACKGROUND

Tattoos are designs made by inserting indelible ink into skin to permanently change the pigment. The permanence of tattoos often causes many people who like the appearance of a tattoo to refrain from getting one. Further, people may wish to have a tattoo for some occasions, but not all occasions. People may also want to change the image of the tattoo over time. Some potential tattoo wearers may also be deterred by the pain, health concerns, or relatively high cost associated with the tattoo procedure

In response to some of these disadvantages, alternatives to permanent tattoos have been created. For example, temporary tattoo paint can be used to paint a design directly onto skin. However, using tattoo paint is time consuming and requires artistic skill. Another, non-permanent option includes a temporary tattoo decal applied to the skin using water to transfer the decal to the skin. With both of these tattoo alternatives, the design only lasts for a few days, may be cumbersome to apply, and may cause skin irritation.

More recently, designs have been printed onto fabrics to provide wearable garments that display the designs. Some of these designs have attempted to resemble tattoos. Conventional printing techniques for transferring the design onto the fabric, however, require the use of high temperatures applied over long time periods. These conventional printing techniques are not suitable for use with sheer nylon material, such as pantyhose or nylons, because these sheer materials do not have a high enough denier or heat tolerance, so the sheer fabric can not endure the required high temperatures needed for the printing process. Denier is the unit of measure for the linear mass density of fibers, and is defined as the mass in grams per 9,000 meters of yarn. Accordingly, a fabric having a high denier is thick and consequently a printed design on the thicker fabric fails to maintain a realistic of appearance of a permanent tattoo.

Other methods of transferring designs onto lower denier or sheer fabric include silk screening or screen printing onto the material hosiery. However, this screen printing technique requires each color to be printed and treated separately, using sequential stencils, making the process time-consuming and cumbersome. Moreover, many methods of printing onto fabrics use plastisol ink, which coats the fabric on which it is transferred. This causes designs to look painted onto fabric instead of on the skin, further decreasing the apparent realism of a tattoo design. The printed fabric is also susceptible to stretching and distortion of the image printed onto the fabric, which decreases the apparent realism of the image. Consequently, it is desirable to provide a sheer garment that creates the illusion of a tattoo on the skin under the garment without the disadvantages of the current methods of manufacturing.

### SUMMARY

The present disclosure is directed to processes for printing a design onto sheer fabric that overcomes problems experienced in the prior art and provides additional benefits. More specifically, the present disclosure is directed to printing realistic tattoo images onto very sheer fabric, such as nylon, elastane, spandex, or other sheer—polyester-based fabric, thereby creating the illusion that a tattoo is under the fabric and on the wearer's skin. The sheerness of nylon is determined by the density of the fibers. Processes in accordance with the present disclosure can apply tattoo-style designs on very sheer fabric, which is almost invisible when worn by the wearer while the tattoo remains visible, thereby increasing the apparent authenticity of the tattoo-style design on the fabric.

Embodiments of the present disclosure include processes that utilize dye sublimation ink and sublimation paper for applying the tattoo design on the sheer nylon. Dye sublimation ink is a pigment suspended in a liquid solvent, e.g., water. In an embodiment of the present disclosure, the dye sublimation ink is permanently transferred to a sheer fabric using a heat press to perform micro-pigment implantation in the fibers. This process creates a realistic tattoo design that looks like it is on the skin when the sheer nylon fabric is worn.

Embodiments of the present disclosure include processes for applying a selected image on sheer fabric, e.g. nylon. The process may include drawing or otherwise applying a selected design onto stipple paper, and scanning the design into a conventional computer to create a digital image of the design. The computer is operatively coupled to a printer that prints with selected dye sublimation ink. The design, such as a tattoo-style design, may then be printed from the computer via the printer onto sublimation paper so that the tattoo-style design is formed by dye sublimation inks on the sublimation paper. The tattoo-style design is then transferred onto a selected portion of the sheer fabric, such as very sheer nylon.

In one embodiment in accordance with the present disclosure, the sublimation paper may be coated. A first sheet of coated sublimation paper has a design printed thereon with dye sublimation ink. The first sheet is placed on a sheer fabric at a desired location, and a second sheet of coated sublimation paper is placed under the portion of the sheer fabric subject to the heat press, sandwiching the sheer fabric between sheets of sublimation paper. The second sheet of coated sublimation paper eliminates the marking from the coating of the first sheet of sublimation paper that would ordinarily be heat set on the sheer fabric while the heat press is applied. A high temperature, high pressure heat press is applied to the sublimation paper to transfer the dye sublimation ink from the sublimation paper to the fabric. Once the heat press transfers the dye, the sheer fabric is permanently dyed so that it can be washed without damaging the quality of the image.

In another embodiment, the sheer fabric is positioned over a heat resistant form configured for use with the heat press. In one embodiment, the heat resistant form is positioned between two layers of the sheer fabric material, such as being positioned within the interior of very sheer nylon hosiery. The heat resistant form creates a barrier between layers of the fabric and supports the fabric during heat pressing. The design on the sublimation paper is placed onto the sheer fabric in a desired location. The heat press is then activated and firmly presses the sheer fabric nylon, the sublimation paper with the design, and the second sheet of sublimation paper (if used) against the heat resistant form for a selected time and at a selected heat until the tattoo design is permanently transferred to the sheer fabric.

Other embodiments in accordance with the present disclosure include processes for printing sheer fabric with a tattoo-style design that includes a black border around the design. Permanent tattoos usually require black borders around colors to prevent ink from running, so the inclusion of black borders creates a more realistic tattoo design.

One embodiment is directed to a process for applying a design on sheer fabric to create the illusion the design is on a wearer's skin. The process comprises printing the design with dye sublimation ink on a first sheet of coated carrier material, and positioning the first sheet of coated carrier material on a first side of the sheer fabric with the design engaging the sheer fabric. A second sheet of coated carrier material is positioned on a second side of the sheer fabric opposite the first sheet with the sheer fabric sandwiched between the first and second sheets of coated carrier material, wherein the second sheet of coated carrier material is larger than the first sheet of coated carrier material. Heat and pressure are applied to the sheer fabric and the first and second sheets of coated carrier materials including at least over the desired location, and the design formed by the dye sublimation ink is transferred from the first sheet of coated carrier material into the fibers of the sheer fabric. The sheer fabric is removed from the first and second sheets after the design has transferred to the sheer fabric and formed a permanent design thereon.

Another embodiment includes process for applying a design on sheer fabric to create the illusion the design is on a wearer's skin. The process comprising: positioning a carrier sheet on a first side of the sheer fabric, the carrier sheet having a design formed by dye sublimation ink thereon, the carrier sheet being positioned with the design engaging the sheer fabric; applying heat and pressure to the sheer fabric and the carrier sheet including at least over the desired location the heat being in the range of approximately 180° C. to 210° C., inclusive, and the heat and pressure being applied for a time period in the range of approximately 10 seconds to 60 seconds, inclusive; transferring the dye sublimation ink from the carrier sheet into the fibers of the sheer fabric to form the design in the sheer fabric at the desired location; and removing the sheer fabric from the carrier sheet after the design has transferred to the sheer fabric and formed a permanent design thereon.

Yet another embodiment includes a process of permanently applying a design on sheer material to create the illusion that the design is on a wearer's skin when the sheer material is worn. The process comprising: positioning the sheer material on a heat press; positioning the design on the sheer material in a desired location, the design configured to transfer ink onto sheer material; and applying a heat and pressure from the heat press to at least the desired location on the sheer fabric, the heat and pressure changes the ink to a gas that permeates the sheer fabric and solidifies into fibers of the sheer fabric, and permanently dying the sheer fabric.

Another embodiment includes a garment having an integral tattoo design. The garment comprising a sheer fabric having a first side and a second side; a tattoo design on first side of sheer fabric, the design being heat pressed into the sheer fabric and configured to appear as though the design is a permanent tattoo under the second side of the sheer fabric when the garment is worn.

Still other embodiments of the present disclosure include hosiery and lingerie having realistic tattoo designs made using the processes described herein. The embodiments may further include hosiery and/or lingerie having more than one design, e.g., around the edges of the lingerie, and on the elastic bands of thigh highs. Additional embodiments include other garments with designs printed using the processes described herein.

In another embodiment, a sheer fabric garment is provided that has multiple tattoo designs or other designs applied as discussed above. A first design is applied in a first portion of the fabric with a first color density, wherein the first portion of the fabric is configured to be stretched a first amount when the garment is worn. A second design is applied to a second portion of the fabric with a second color density different then the first color density, and wherein the second portion of the fabric is configured to be stretched a second amount different then first amount. The first design is applied to the first portion of the fabric in the manner described above, wherein a first temperature (or amount of heat) for a first time duration at a first pressure is used, and the second design is applied to the second portion of the fabric in the manner described above, wherein a second temperature (or amount of heat) for a second time duration at a second pressure is used. At least one of the second temperature, second time duration, or second pressure is different then the first temperature, first time duration, or first pressure, respectively. In another embodiment, the second temperature and second time duration is different than the first temperature and first time duration. As a result, the color density of the second design is different than the color density of the first design so that, when the garment is worn and the first and second portions of the fabric are stretched two different amounts, the first and second designs appear to have similar color densities when in the stretched configuration.

### BRIEF DESCRIPTION OF THE DRAWINGS

FIG. 1 is a schematic flow chart of a process for applying a design on sheer fabric in accordance with an embodiment of the present disclosure.

FIG. 2A is a schematic view of a heat press with a sheer fabric garment in position for application of a tattoo design in accordance with an embodiment of the present disclosure.

FIG. 2B is a schematic view of a heat press and heat resistant form used during the process for applying a tattoo design to sheer fabric in accordance with an embodiment of the present disclosure.

FIGS. 3-6 are illustrations of sheer hosiery in accordance with embodiments of the present disclosure.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

### DETAILED DESCRIPTION

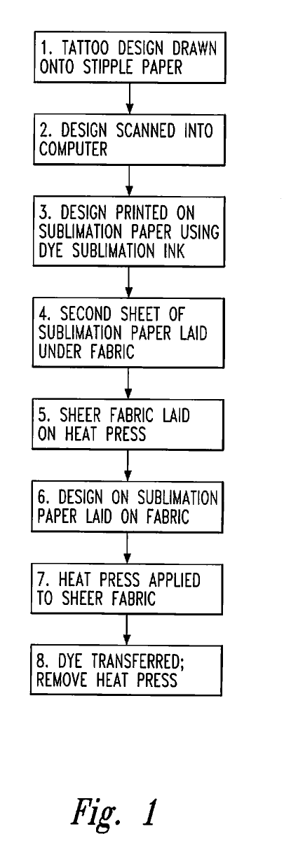

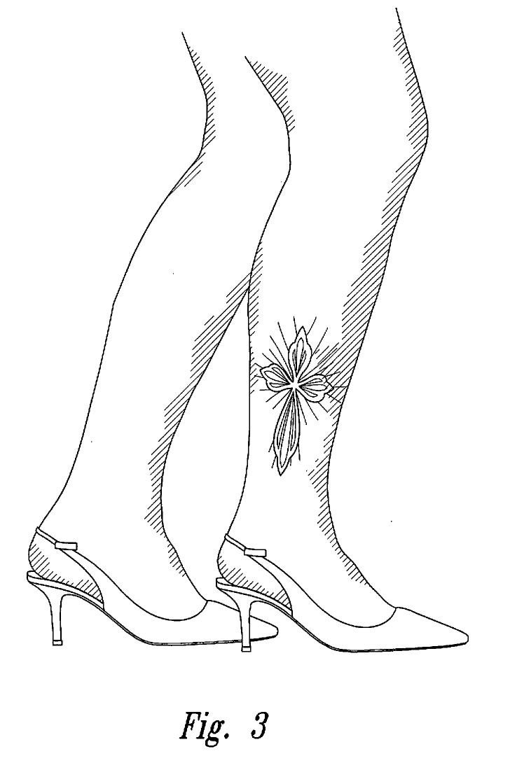

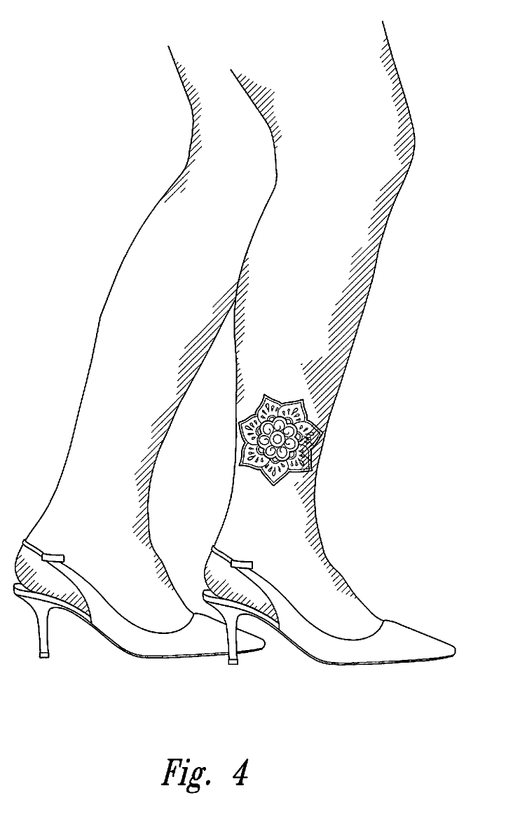

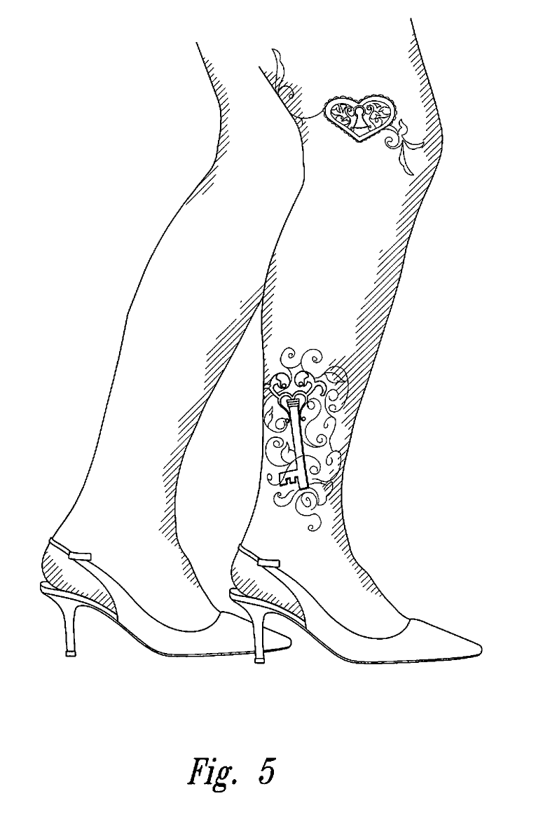

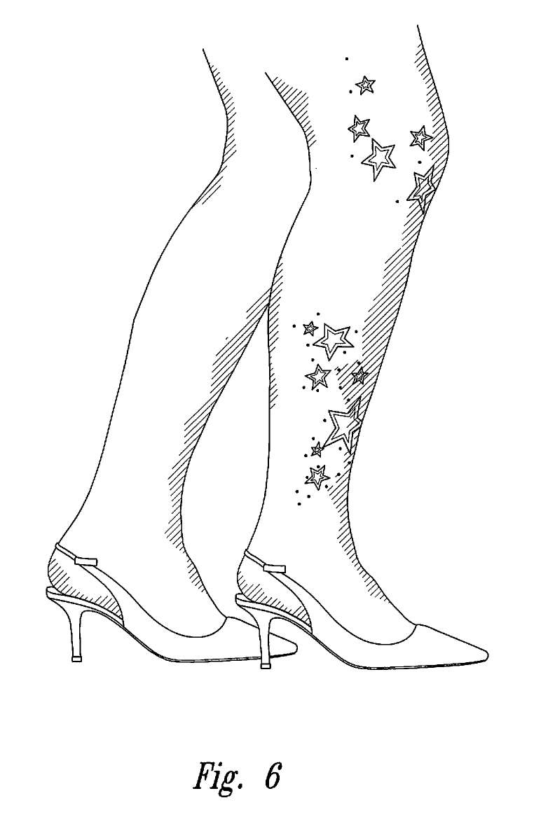

The following describes embodiments of processes for printing a design on sheer fabric and the products made thereby. Embodiments in accordance with the present disclosure are set forth hereinafter to provide a thorough understanding and an enabling description of a number of particular embodiments. Several specific details of the disclosure are set forth in the following description and in FIGS. 1-6. A person skilled in the art will understand, however, that the invention may have additional embodiments, or that the invention may be practiced without one or more of the specific details of the embodiments as shown and described. For example, FIGS. 3-6 illustrate sheer hosiery having a design in accordance with the present disclosure. However, it should be noted that hosiery is only one type of a garment made using the disclosed processes. The processes described below can be used to make any suitable garment, including, but not limited to, hosiery, lingerie, shirts, pants, underwear, swimsuits, gloves and other apparel.

Processes in accordance with this disclosure may be practiced without one or more of the specific steps disclosed herein. For example, the processes described below include dye sublimation ink and sublimation paper. However, it should be noted that other types of ink capable of being suitably applied to fabric including very sheer fabric, creating the illusion of a tattoo-style design, is on the skin under the fabric may be used, including, but not limited to, optic color ink and ultra-violet florescent ink. Furthermore, the processes described below are not limited to tattoo designs. Instead, other designs can be printed on the sheer fabric to create the illusion it is on the person's skin under the fabric. For example, other designs may include, but are not limited to, body paint and/or branding images, trademarks, characters, text, muscle defining lines, skin pigmentation changes, etc.

FIG. 1 is a schematic flow chart showing sequential steps of an embodiment of a process in accordance with the present disclosure. Step 1 of the process includes drawing or otherwise creating a tattoo or other selected design on stipple paper. The design may resemble a tattoo by having black outlines. The design may further include one or more colors with desired color gradients (if any) within the black outlines. In the illustrated embodiment, the tattoo-style design is drawn or otherwise applied to the stipple paper with the same outline and/or color gradient as a tattoo design that would be permanently applied to a person's skin as a real tattoo. Therefore, this step makes the tattoo-style design look extremely realistic, rather than like a stamp. In alternative embodiments, the design need not be drawn on stipple paper. After the selected design is complete, the design is scanned into a computer using known methods of scanning images (Step 2).

Step 3 includes printing the design on sublimation paper using dye sublimation ink. Dye sublimation ink is water-soluble, which allows the ink to penetrate fibers in a fabric without modifying the characteristics of the fiber. For example, dye sublimation ink will change the color of the nylon fibers that create sheer hosiery, but the sublimation ink does not alter the sheen of hosiery. Using conventional techniques for applying paint or most non-water soluble dyes merely coats the fibers of the fabric, thereby destroying the sheen or other fiber characteristics and resulting in a design that looks simply painted on the fabric. Such a “painted-on” design would not achieve the realistic appearance provided by the illustrated embodiment of a tattoo on the skin under the fabric.

Step 3 in the process of the illustrated embodiment includes printing the design on the sublimation paper in reverse of the final design that will be seen when the hosiery is worn. This reverse printing provides the correct orientation of the design for transfer onto to the fabric. In alternate embodiments of the present disclosure, designs may be created directly on the computer without using stipple paper. The design is then printed from the computer onto the sublimation paper using dye sublimation ink. In further embodiments, the designs may be created using optic color ink, ultra violet florescent ink, or any other suitable ink that does not coat the fibers of the sheer fabric.

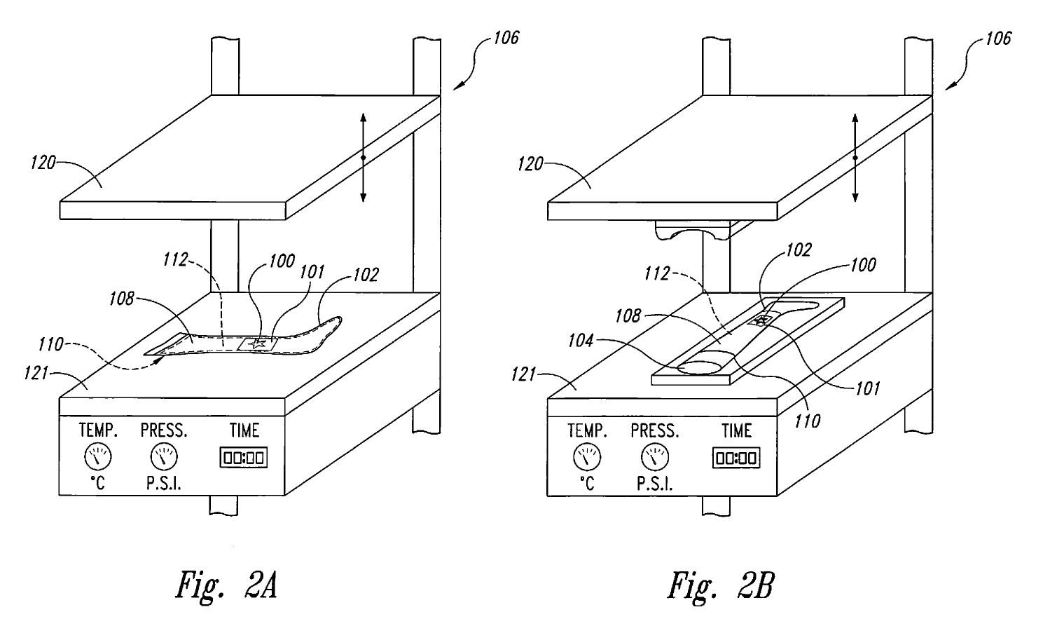

The design 100 is transferred from the sublimation paper 101 to the sheer fabric 102 using a conventional heat press machine 106 (FIG. 2A). In the illustrated embodiment, the tattoo design 100 is transferred from the sublimation paper 101, or other suitable transfer paper/layer, onto a selected portion of very sheer nylons. The nylons have the tubular configuration to snugly fit over the wearer's foot, ankle, and leg. The nylons can be thigh-high nylons, or pantyhose. Accordingly, when the nylons are laid out flat, the portion that receives the wearer's legs has two layers 108 and 110 of the very sheer material, one lying atop the other. To insure that the selected tattoo design is transferred to the desired area on only one layer of the nylons, an intermediate layer 112 or form 104 (FIG. 2B) is positioned inside the nylons between the two sheer fabric layers.

The intermediate layer can be a substantially flat sheet of paper or other barrier that will prevent the sublimation ink from bleeding through and dying the other layer or side of the nylons. The intermediate layer can be shaped to conform to all or a portion of the interior area of the nylons. In another embodiment, a heat resistant form, such as thicker, three-dimensional shaped support structure, can be positioned within the interior area of the nylons to act as an intermediate structure between the two layers of sheer fabric. This intermediate structure also insures that the sublimation dye is only applied to one layer or side of the sheer nylons without bleeding through to the other layer or side. The intermediate structure can also provide a backing structure against which the sheer nylon fabric is pressed via the heat press during the dye transfer processes.

In one embodiment, the tattoo design is printed onto a piece of sublimation paper that is slightly larger that the tattoo design. Accordingly, when the piece of sublimation paper is placed on the sheer nylon fabric during the transfer process, the piece of sublimation paper only covers a small portion of the sheer nylon fabric. The sublimation paper typically includes a finish on the surface, such as a polymeric coating, so the sublimation inks will not saturate into the paper backing, thereby providing full image release from the sublimation paper during the design transfer process. In one embodiment, the design transfer process uses the heat press to apply heat and pressure to the sublimation paper that carries the tattoo design. The heat and pressure, however, results in the full transfer the tattoo design and the polymeric coating to the sheer nylon fabric. This transfer of the polymeric coating can result in a very faint outline of the piece of sublimation paper on the sheer nylon fabric. This faint outline of the sublimation paper generally around the tattoo design may be seen under certain lighting conditions. Such an outline of the sublimation paper around the tattoo design can be highly undesirable.

In the illustrated embodiment of FIG. 2A, an intermediate sheet of blank sublimation paper 112 is placed in the interior area of the nylons between the two layers of sheer fabric 108 and 110. The blank sublimation paper 112 has the polymeric coating, and the side with the coating is positioned to face toward the layer of the sheer fabric onto which the tattoo design will be transferred. The intermediate sheet of sublimation paper may be shaped and sized to correspond to the entire the layer 108 of sheer nylon onto which the tattoo design will be applied. Accordingly, if the tattoo design 100 is to be applied to the ankle area of thigh-high hosiery, the intermediate sheet of sublimation paper may be shaped generally like a two-dimensional outline of a leg, ankle and foot. When the tattoo design is transferred to the sheer nylon fabric, the polymeric coating material from both pieces of sublimation paper (the intermediate layer and the design layer) will be applied to the nylon fabric and will blend together. As a result, there will be no outline of the sublimation paper from which the tattoo design was transferred.

Returning to FIG. 1, Step 4 includes positioning the intermediate sheet of coated sublimation paper immediately adjacent to the layer of sheer nylon fabric to which the tattoo design will be applied. In one embodiment, the intermediate sheet of sublimation paper is shaped and sized to substantially correspond to all or a very large portion of the nylons within which the tattoo design will be applied. The intermediate sheet is positioned within the nylons between the two layers of sheer nylon fabric when the nylons are laid out flat.

Step 5 includes placing the nylons with the sheet of intermediate sublimation paper therein in the heat press, such as on a bottom plate of the heat press. Accordingly, the layer of sheer nylon fabric to which the tattoo design will be applied faces away from the bottom plate and toward the top plate of the heating press. In this arrangement the bottom layer of the sheer nylon is adjacent to the lower plate of the heat press. In some embodiments, a barrier layer may be provided between the bottom nylon layer and the lower plate if such isolation or partial isolation of the bottom nylon layer is desirable. For example, it may be desirable to isolate the bottom nylon layer from unnecessary exposure to direct heat from the heat press, while the top layer is exposed to the direct heat for completion of the image transfer.

In another embodiment shown in FIG. 2B, the sheer fabric 102 can be positioned on a heat-resistant form 104 configured to work with the heat press 106. In this embodiment, the heat resistant form 104 is placed inside the interior area of the nylons to separate the top layer 108 of the sheer fabric from the lower layer 110 of the sheer fabric. The intermediate sheet of sublimation paper 112 can be positioned within the interior area of the nylons between the heat resistant form 104 and the upper layer 108 of the sheer fabric to which the tattoo design 114 will be applied. The heat resistant form 104 may be a plastic resin, however, it should be noted that the form may be made out of any suitable material.

Returning again to FIG. 1, Step 6 includes placing the sublimation paper having the tattoo design printed thereon, onto the upper layer of sheer fabric at a desired location, such that the dye sublimation ink is facing the fabric. Since the tattoo design is printed in reverse, the design transferred to the sheer fabric will have the correct orientation. The second sheet of sublimation paper is positioned under the full portion of the sheer fabric's upper layer that will be directly exposed to the heat and pressure from the heat press. Accordingly, at least a portion of the upper layer of sheer nylon fabric is sandwiched between two sheets of sublimation paper with the coated/printed surfaces facing each other. Preferably, most of the fabric is exposed to the heat press so that any marking from the second sublimation paper is restricted to the outer limits of the fabric, or not on the fabric at all. In additional embodiments, the first and second sheets of sublimation paper may be placed in opposite positions, i.e., the first sheet of sublimation paper having the design is placed under the layer of sheer fabric and the second sheet of sublimation paper is placed over the layer of sheer fabric.

In an alternate embodiment, the tattoo design is printed onto a coated sheet of sublimation paper sized to substantially cover the full portion of the sheer fabric that will be exposed to the heat press. Accordingly, the tattoo design transfer can be accomplished using only one sheet of the sublimation paper. Again, it is preferable to expose most of the sheer fabric to the heat press so any markings from the sublimation paper are restricted to the outer limits of the fabric, or not at all.

Step 7 and Step 8 include the actual ink transfer process. Step 7 includes applying heat and pressure via a heat press to the sheet of sublimation paper carrying tattoo design and to the layer of sheer fabric. As shown in FIG. 2A, the upper and lower plates 120 and 121 are pressed together and the plate 120 of the heat press 106 is firmly pushed onto the back of the sublimation paper carrying the tattoo design and onto the layer of sheer fabric. The heat press 106 provides the heat and pressure that transfers the dye sublimation ink from the sublimation paper 104 into the sheer fabric 102. Due to the characteristics of the dye sublimation ink, under high temperature and high pressure, the ink turns to a gas, permeates the fabric, and solidifies into its fibers. The entire tattoo design, including every color, is transferred into the sheer fabric during this one step.

For purposes of an example for illustrative purposes only, the heat press 106 may be applied to the sheer fabric and the layer(s) of sublimation paper for approximately ten to sixty seconds at a temperature of 180 to 210 degrees Celsius. It is noted that the strike point or melting temperature of the sheer fabric may be less than the temperature of the heat press. For example, the melting point of a sheer nylon may be approximately 185 degrees Celsius, and the temperature of the heat press may be over 185 degrees Celsius. The tattoo or other design is transferred without melting the nylon or destroying the fibers' integrity because the nylon is at approximately room temperature before being put into the heat press. The hot surfaces of the heat press cause the nylon fibers to heat up, but the time period and/or pressure during which the fibers are exposed to the elevated temperature is selected is so that the actual temperatures of the nylon fibers will increase but will not reach or exceed the fiber's melting point. As the nylon fibers heat up, the sublimation ink also heats up and is transferred into the fibers, so as to fully transfer the design from the sublimation paper. Accordingly, this time and temperature create desirable results that transfer the entire tattoo design into the nylon fabric at a selected color density within the fibers without compromising the integrity of the sheer fabric.

In additional embodiments, more or less heat and/or time may be used to transfer the sublimation ink into the nylon with the desired concentration. For example, more pressure and/or more heat can be used increase the amount of dye transferred to the sheer fabric. Accordingly, the intensity or concentration of the ink transferred into the sheer nylon fabric can be carefully controlled using the appropriate application of heat and pressure to the sublimation paper and the sheer fabric while ensuring that the sheer fabric (e.g., nylon) is not melted, scorched, or otherwise damaged during the ink transfer process. After the tattoo design has been transferred to the upper layer of sheer fabric, Step 8 includes removing the sheer fabric with the tattoo design thereon from the heat press. The dye is now permanently transferred to the sheer fabric, and the nylons can be packaged, worn, washed, or otherwise used normally without damaging the quality of the tattoo design.

In further embodiments of processes in accordance with present disclosure, Steps 1 through 8 may be repeated to add additional designs to the sheer fabric. A design may be added to the elastic band of a thigh high nylon stocking to create an appealing appearance. It should be noted that designs may be placed anywhere on the sheer fabric.

In another embodiment, a sheer fabric garment is provided that has multiple tattoo designs or other designs applied as discussed above. When the garment is worn, different portions of the sheer fabric are stretched by different amounts. For example, when the garment is sheer thigh-high nylons, the portion of the sheer nylon fabric that fits around the wear's ankle is typically stretched substantially less than the portion of the nylon fabric that fits around the wearer's thigh. If a design provided at the ankle region has the same color density as the design provided the thigh region, when the nylons are worn, the design in the thigh region will be stretched more than design in the ankle region. As a result, the design in the thigh region could appear to be substantially more faded or less distinct than the design in the ankle region. To overcome this situation, the design in the thigh region (or the portion of the fabric that will stretch more) is applied so as to have a greater color density than the design in the ankle region (or other region that will stretch less). Thus, when the garment is worn, the two designs will appear to have similar color densities even though one is stretched more than the other.

As an example, a first tattoo design is applied in a portion of the sheer fabric with a first color density, and a second tattoo design is applied to a second portion of the fabric with a second color density greater then the first color density. The second portion of the fabric is configured to be stretched a greater amount then first amount. The first tattoo design is applied to the first portion of the fabric in the manner described above, wherein a first temperature (or amount of heat) is applied to the sheer nylon fabric and the sublimation paper carrying the first design for a first time period at a first pressure. The second tattoo design is applied to the second portion of the fabric in the manner described above, wherein a second temperature (or amount of heat) is applied to the second portion of the sheer nylon fabric and the sublimation paper carrying the second design for a second time period at a second pressure. At least one of the second temperature, second time period, or second pressure is different then the first temperature, first time period, or first pressure, respectively. In one embodiment, the second temperature and the second time period is different than the first temperature and first time period, but the first and second pressure are substantially the same. In another embodiment, the heat press is maintained at substantially the same temperature so the first and second temperatures are approximately the same, but the first and second time periods are the different.

It is noted that while the heat press may have heated surfaces maintained at a selected temperature, when the sheer nylon fabric is pressed between the heated plates, the nylons fibers and the sublimation ink on the sublimation paper are not instantly at the same temperature as the heated plates. Instead, the heated plates cause the temperature of the nylon fibers and the sublimation ink to increase in temperature. The longer the sheer nylon fabric and the sublimation ink are exposed to the heated plates, the closer their respective temperatures will approach the temperature of the heated plates. This means that the longer the heat is applied, the closer the actual temperatures of the nylon fibers and/or the sublimation ink will get to the temperature of the heating plates. Accordingly, the temperature of the heating plates, the amount of time the heat is applied, and the pressure applied to the fabric and the sublimation ink must be carefully balanced and controlled so that the sheer fabric does get too close to the strike point or melting temperature, while insuring that adequate ink transfer occurs to provide the desired color density of the design in the fibers in the selected portions of the fabric. When the first and second tattoo designs are applied to different portions of the sheer nylon fabric using different temperatures, time periods and/or pressures, color density of the second tattoo design will be different than the color density of the first tattoo design. Accordingly, when the garment is worn and the first and second portions of the fabric are stretched two different amounts, the first and second tattoo designs appear to have similar color densities when in the stretched configuration.

In other embodiments, multiple designs may be simultaneously transferred to the sheer fabric at the same time. For example, multiple designs may be printed onto one or more pieces of sublimation paper using the dye sublimation ink as discussed above. The multiple designs can be transferred to the nylons using one or more heat/pressure cycles in the heat press.

In at least one embodiment, the nylons are in the form of thigh-high nylons with an elastic upper band area at the top of the nylons. The elastic band area is colored with a bright band of one or more colors. For example, very sheer, nude colored thigh-highs with one or more tattoos on them may be provided with an orange, blue, green, or pink top band. Other configurations can use other colors at the top band. This top band area can be colored with the sublimation dye ink or other coloring processes. In addition, selected tattoo designs may be included in the top band portion using the process discussed above.

The above embodiments are discussed in connection with designs that resemble a tattoo. However, it should be noted that the process described above may be used to print any design on the very sheer fabric to create the illusion that the design is on the wearer's skin under the sheer fabric when the fabric is worn. For example, embodiments in accordance with the present disclosure may include, but are not limited to, a design resembling a brand, characters, body paint, or body/muscle definition.

FIGS. 3-6 are examples of garments with tattoo-style designs printed thereon using an embodiment of the process described above. More specifically, FIGS. 3-6 illustrate highly sheer hosiery that is worn on a woman's leg. Women's hosiery is usually woven from nylon fiber that has a denier between fifteen and twenty, the higher denier making the fabric sheerer. Very sheer hosiery is almost invisible, and, therefore, increases the illusion that a design, i.e., the tattoo on the sheer hosiery, is on the skin. In one embodiment of the present disclosure, the hosiery may be made of highly sheer CHO1 fabric, which has a denier of 15 and is made of 88% nylon and 12% spandex. The fabric has a construction of 20 denier spandex filament wrapped by a 12 denier nylon filament with five filaments (2012D/5F), and an 18 denier nylon with five filaments (18D/5F). The sheer fabric is processed by sequentially layering one course of the 2012D/F over one course of the 18D/5F. This construction gives the hosiery a translucent appearance suitable for most skin tones, while maintaining its integrity during the heat pressing process described above since it has a melting point of around 240 to 260 degrees Celsius.

It should be noted that this is only one material composition for hosiery having a tattoo design printed thereon using the process described above. Other suitable material compositions for hosiery will be known to persons having skill in the art. Additionally, it should be noted that the placement of the designs in FIGS. 3-6 are only examples of design positions, and that designs may be positioned anywhere on the hosiery. Furthermore, the sheer hosiery may have a variety of colors to match skin tone. This allows people with darker skin to enjoy the vibrant colors of tattoos sometimes unattained with other temporary and permanent tattoos.

Another embodiment in accordance with the present disclosure includes sheer lingerie having design printed thereon by the processes described above. The lingerie may be 82% nylon and 18% spandex having a construction of 20 denier nylon and 70 denier spandex. The weight of the fabric is 60 grams per square meter. It should be noted that this is only one material composition for lingerie having a tattoo design printed thereon, and other suitable material compositions for lingerie will be known to persons having skill in the art.

From the foregoing, it will be appreciated that specific embodiments of the invention have been described herein for purposes of illustration, but that various modifications may be made without deviating from the spirit and scope of the invention. Additionally, aspects of the invention described in the context of particular embodiments or examples may be combined or eliminated in other embodiments. Although advantages associated with certain embodiments of the invention have been described in the context of those embodiments, other embodiments may also exhibit such advantages. Additionally not all embodiments need necessarily exhibit such advantages to fall within the scope of the invention. Accordingly, the invention is not limited except as by the appended claims.

I claim:

1. A process for applying a design on sheer fabric to create the illusion the design is on a wearer's skin, the process comprising:
printing the design with dye sublimation ink on a first sheet of coated carrier material;
positioning the first sheet of coated carrier material on a first side of the sheer fabric with the design engaging the sheer fabric;
positioning a second sheet of coated carrier material on a second side of the sheer fabric opposite the first sheet with the sheer fabric sandwiched between the first and second sheets of coated carrier material, wherein the second sheet of coated carrier material is larger than the first sheet of coated carrier material.
applying a heat and pressure to the sheer fabric and the first and second sheets of coated carrier materials including at least over the desired location;
transferring the design formed by the dye sublimation ink from the first sheet of coated carrier material into the fibers of the sheer fabric; and
removing the sheer fabric from the first and second sheets after the design has transferred to the sheer fabric and formed a permanent design thereon.

2. The process of claim 1 wherein the heat is applied at a temperature within the range of approximately 180° C. to 210° C., inclusive, and the heat and pressure are applied for a time period in the range of approximately 10 seconds to 60 seconds, inclusive.

3. The process of claim 1 wherein printing a design with dye sublimation ink on a sheet of sublimation paper further comprises:
drawing the design on a sheet of stipple paper;
coloring the design on the stipple paper with a plurality of colors, wherein individual colors have a color gradient;
scanning the design into a computer device; and
printing the scanned design from the computer onto the sheet of sublimation paper using dye sublimation ink, the design being configured to be the mirror-image of the design printed on the sheer fabric.

4. The process of claim 1 wherein the sheet of sublimation paper is coated with a polymeric material.

5. The process of claim 1, further comprising positioning a substantially heat resistant form adjacent to the sheer fabric with the sheet of second coated carrier material between the form and the sheer fabric.

6. The process of claim 1 wherein at least one of the first and second sheets of coated carrier material is sublimation paper.

7. The process of claim 6 wherein the sheer fabric form nylons with a leg, ankle and foot portions, and transferring the design includes transfering the design to the leg portion adjacent to the ankle portion.

8. The process of claim 1 wherein the design comprises a black border and a plurality of colors within the black border, the colors having color gradients, and transferring the design includes transferring the design so the design on the sheer material has the appearance of a permanent tattoo.

9. The process of claim 1 wherein the sheer fabric comrpises 18% spandex and 82% nylon, the nylon having a denier of 20 denier and the spandex having a denier of 70.

10. The process of claim 1 wherein the fabric comprises 88% nylon and 12% spandex, the construction having a denier of 15 and including 20 denier spandex filament wrapped by 12 denier nylon filament, the nylon filament having 5 filaments, and an 18 denier nylon filament.

11. A process for applying a design on sheer fabric to create the illusion the design is on a wearer's skin, the process comprising:
positioning a carrier sheet on a first side of the sheer fabric, the carrier sheet having a design formed by dye sublimation ink thereon, the carrier sheet being positioned with the design engaging the sheer fabric;
applying heat and pressure to the sheer fabric and the carrier sheet including at least over the desired location the heat being in the range of approximately 180° C. to 210° C., inclusive, and the heat and pressure being applied for a time period in the range of approximately 10 seconds to 60 seconds, inclusive;
transferring the dye sublimation ink from the carrier sheet into the fibers of the sheer fabric to form the design in the sheer fabric at the desired location;
and removing the sheer fabric from the carrier sheet after the design has transferred to the sheer fabric and formed a permanent design thereon.

12. A process of permanently applying a design on sheer material to create the illusion that the design is on a wearer's skin when the shear material is worn, the process comrpising:
positioning the sheer material on a heat press;
positioning the design on the sheer material in a desired location, the design configured to transfer ink onto sheer material; and
applying a heat and pressure from the heat press to at least the desired location on the sheer fabric, the heat and pressure changes the ink to a gas that permeates the sheer fabric and solidifies into fibers of the sheer fabric, and permanently dying the sheer fabric.

13. The process of claim 12 wherein the ink is dye sublimation ink printed onto a first sheet of coated sublimation paper, the process further comprising:
positioning a second sheet of coated sublimation paper under the portion of the sheer fabric exposed to the heat and pressure, the second sheet of coated sublimation paper being larger than the first sheet of coated sublimation paper; and
applying the heat and pressure to the first and second sheets of coated sublimation paper.

14. The process of claim 12 wherein the heat press has a temperature in the range of approximately 180° C. to 210° C., inclusive, and the process further comprises:
applying the heat and pressure to the sheer fabric for a time period in the range of approximately 10 to 60 seconds.

15. The process of claim 12 wherein positioning the design comrpises:
creating a design having an outline and color gradient resembling a permanent tattoo;
capturing the design into a computer; and
printing the captured design from the computer onto the sublimation paper in a mirror image of the scanned design.

16. The process of claim 12 wherein the ink is optic color ink.

17. The process claim 12 wherein the ink is ultra violet florescent ink.

18. A garment having a tattoo design comprising:
a sheer fabric having a first side and a second side;
a tattoo design on first side of sheer fabric, the design being heat pressed into the sheer fabric and configured to appear as though the design is a permanent tattoo under the second side of the sheer fabric when the garment is worn.

19. The garment of claim 18 wherein the garment is lingerie, and the lingerie comprises 18% spandex and 82% nylon, the nylon having a denier of 20 denier and the spandex having a denier of 70.

20. The garment of claim 18 wherein the garment is hosiery, and the hosiery comprises 88% nylon and 12% spandex, the construction having a denier of 15 and including 20 denier spandex filament wrapped by 12 denier nylon filament, the nylon filament having 5 filaments, and an 18 denier nylon filament.

21. The garment of claim 18 wherein the garment is a hosiery configured to be worn on an a wearer's leg.
